(19) United States
(12) Patent Application Publication
(10) Pub. No.: US 2023/0222450 A1
(43) Pub. Date: Jul. 13, 2023

(54) MACHINE LEARNING IN EMPLOYEE SELF-SERVICE SYSTEM FOR RETIREMENT PLAN CONTRIBUTIONS

(71) Applicant: ADP, Inc., Roseland, NJ (US)

(72) Inventors: Sanjay Varma Rudraraju, Florham Park, NJ (US); Ankush Chauhan, Florham Park, NJ (US); Cary Feuer, Florham Park, NJ (US); Hemlata Rawal, Alpharetta, GA (US); Steve P. Little, Florham Park, NJ (US)

(21) Appl. No.: 17/647,430

(22) Filed: Jan. 7, 2022

(51) Int. Cl. G06Q 10/10; G06N 20/00; G06Q 40/06

(52) U.S. Cl. CPC G06Q 10/1057; G06N 20/00; G06Q 40/06

(57) ABSTRACT

A system, method, and computer program product for setting an employee contribution to a retirement plan are disclosed. The method includes: assigning, by a computer system, each employee in a plurality of employees to one of a plurality of clusters by processing socio-economic information for the plurality of employees using machine learning to generate a machine learning model; determining, by the computer system, a benchmark for each cluster in the plurality of clusters from a characteristic of contributions to a retirement plan of the employees assigned to the cluster; identifying, by the computer system, a selected cluster in the plurality of clusters for a selected employee using the machine learning model; and controlling displaying, by a graphical user interface, the benchmark for the selected cluster to the selected employee.

### BACKGROUND INFORMATION

### 1. Field

The present disclosure relates generally to systems and methods for setting an employee contribution to a retirement plan. More particularly, the present disclosure relates to a system and method for setting an employee contribution to a retirement plan including: assigning each employee in a plurality of employees to one of a plurality of clusters by processing socio-economic information for the plurality of employees using machine learning to generate a machine learning model; determining a benchmark for each cluster in the plurality of clusters from a characteristic of contributions to a retirement plan of the employees assigned to the cluster; and identifying a selected cluster in the plurality of clusters for a selected employee using the machine learning model.

### 2. Background

In America 63% of working population feel that they are not on track to retire and Retirement is termed as one of the biggest financial challenges of the 21^{st} century. ADP retirement services (RS) has nearly 3.5-4 million clients' employees who are eligible to contribute in their company retirement plan. But out of that nearly 50% of them don't even enroll in their retirement plan and over 70% of the enrolled employees under participate i.e., they don't contribute enough to be on track for retirement.

Based on multiple studies and user research, there are two primary reasons for not enrolling and under participation. The first is that people just don't make enough money to contribute to retirement or at least they think so. The second is that even if they can contribute to retirement, they are not sure if they need to save for retirement or how much they need to save for retirement. In the past many companies attempted to address these issues by creating calculators which will show a potential enrollee useful information regarding how much they need to save to retire. But in the age of hyper personalization, giving generic advice to users based on simple mathematical calculations is insufficient.

Accordingly, it would be beneficial to have a method and apparatus that take into account one or more of the issues discussed above as well as possibly other issues.

### SUMMARY

Embodiments of the present disclosure can include the idea of personalizing the advice to clients' employees (hereafter referred to as participants). Embodiment of the present disclosure can include a personalization methodology based on the supposition that socio-economic factors are the biggest indicator of a person's likeliness to contribute to a 401k. For example, the needs and plans of a 28-year-old single male living in New York City are different from a 28-year-old married male with children living in upper Michigan. Embodiments of the present disclosure can segment users into smaller groups based on their socio-economic factors using artificial intelligence (machine learning) and benchmarks for each group that would be then shown to people based on the group they belong to. Embodiments of the present disclosure can include benchmarks such as 1) % of people like them who are already enrolled in a 401k; 2) average contribution % of people like them; and 3) contribution % of the top savers in their group.

These benchmarks are more impactful because they are not generic or vague but rather account for socio-economic factors of the individual. Embodiments of the present disclosure can use personalization to enhance user engagement time on an employee self-service system and help users plan better for retirement.

An embodiment of the present disclosure provides a method of setting an employee contribution to a retirement plan, comprising: assigning, by a personalized voluntary deduction planning system, each employee in a plurality of employees to one of a plurality of clusters by processing socio-economic information for the plurality of employees using machine learning to generate a machine learning model; determining, by the personalized voluntary deduction planning system, a benchmark for each cluster in the plurality of clusters from a characteristic of contributions to a retirement plan of the employees assigned to the cluster; identifying, by the personalized voluntary deduction planning system, a selected cluster in the plurality of clusters for a selected employee using the machine learning model; and controlling displaying, by a graphical user interface, the benchmark for the selected cluster to the selected employee.

Another embodiment of the present disclosure provides an apparatus for setting an employee contribution to a retirement plan, comprising: a human resources management system comprising an employee self-service system; a personalized voluntary deduction planning system coupled to the human resources management system, the personalized voluntary deduction planning system comprising a personalized retirement planning system, the personalized voluntary deduction planning system configured to assign each employee in a plurality of employees to one of a plurality of clusters by processing socio-economic information for the plurality of employees using machine learning to generate a machine learning model; determine a benchmark for each cluster in the plurality of clusters from a characteristic of contributions to a retirement plan of the employees assigned to the cluster; and identify a selected cluster in the plurality of clusters for a selected employee using the machine learning model; and a graphical user interface coupled to the human resources management system, the graphical user interface comprising a personalized payroll interface comprising a personalized retirement planning interface, the graphical user interface is configured to control display of the benchmark for the selected cluster to the selected employee.

Yet another embodiment of the present disclosure provides a computer program product for setting an employee contribution to a retirement plan, the computer program product comprising a computer readable storage medium having program instructions embodied therewith, the program instructions executable by a device to cause the device to: assign, by a personalized voluntary deduction planning system, each employee in a plurality of employees to one of a plurality of clusters by processing socio-economic information for the plurality of employees using machine learning to generate a machine learning model; determine, by the personalized voluntary deduction planning system, a benchmark for each cluster in the plurality of clusters from a characteristic of contributions to a retirement plan of the employees assigned to the cluster; identify, by the personalized voluntary deduction planning system, a selected cluster in the plurality of clusters for a selected employee using the machine learning model; and control display, by a graphical user interface, the benchmark for the selected cluster to the selected employee.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a payroll processing environment in accordance with an illustrative embodiment;

FIG. 3 is an illustration of a block diagram of a personalized retirement planning system in accordance with an illustrative embodiment;

FIG. 4 is an illustration of a user interface display in a personalized retirement planning system in accordance with an illustrative embodiment;

FIG. 5 is an illustration of another user interface display in a personalized retirement planning system in accordance with an illustrative embodiment;

FIG. 6 is an illustration of another user interface display in a personalized retirement planning system in accordance with an illustrative embodiment;

FIG. 7 is an illustration of a flowchart of a process for a personalized retirement planning system in accordance with an illustrative embodiment;

FIG. 8 is an illustration of a flowchart of a more detailed process for a personalized retirement planning system in accordance with an illustrative embodiment; and

FIG. 9 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account factors such as 1) compensation, 2) age, 3) gender, 4) marital status, 5) tenure in current company, 6) residence state and 7) rate type (hourly or salaried). This data can be read from a data cloud that can in-turn compile it from one or more payroll databases.

The illustrative embodiments can include a series of statistical tests to determine which socio-economic factors influence a person's action to enroll or contribute in a 401k. For instance, one such series resulted in compiling the above 7 factors which clearly can influence someone's decision.

From these factors, the data available from payroll sources can be read. Since ADP pays 1 in every 5 Americans, this one source presents data of around 20% of the working population in America. This data can then be fed into a machine learning model which segments people into smaller groups. For example, all the 40-50M working people in America can be broken down into 4 groups (clusters) namely A, B, C, and D. (Of course, this is just an example and embodiments of this disclosure can have a higher or even lower number of groups). Once all individuals are put in these groups by the machine learning model, illustrative embodiments can determine benchmarks for every group. For example, what percentage of people in the group have already enrolled in a 401k or what is the average percent of their paycheck that is contributed by individuals in the group.

Let's say Alice belongs to Group A then it is likely that Alice is in similar financial situation as other individuals in her group which means that the benchmarks, we show to her are more attainable for her and are also indicative of what people similar to her are doing. These benchmarks can then be controllably displayed (surfaced) to one or more participants in their retirement dashboard and various other locations to encourage and help them retire better.

An advantage of this solution is that the groups are not static and can change dynamically based on the economic climate since illustrative embodiments can be run every week, month or quarter. So, benchmarks shown during a good bull market are going to different from benchmarks shown during a bear market or a disruption, say, a pandemic. This features enables accounting for contextual factors such as an economic situation to avoid giving hypothetical numbers which are out of context unattainable.

An illustrative embodiment will now be outlined in two parts for clarity.

### First Part:

A. Define Clusters: Use all clean anonymized employee payroll records to break them into smaller groups (clusters). Each cluster represents people with similar soci-economic factors.
B. Create RS Benchmarks: Using employee 401k/ROTH contribution data, create the following benchmarks
1. Average Contribution Percent of all employees in each cluster who are actively contributing to a 401k or ROTH
2. Average Contribution Percent of the top ten percent contributors in each cluster
3. Percentage of people in a cluster who are actively contributing to a 401k or ROTH

### Second Part:

C. Send unique identifier of retirement services (RS) Participants to Data Cloud: The unique identifier of every employee (participant) who has 401k through Retirement Services will be sent to Data Cloud in order to assign them a cluster number.
D. Assign Cluster for PS Participants: —The data elements for clustering i.e., compensation, age, etc., will be read for every participant: and based on the definitions obtained for clusters we assign a cluster for each RS participant.
E. Show benchmarks to Participants

Some preferred embodiments of this disclosure can include reading the socio-economic information from payroll information for the plurality of employees. Preferred embodiments of this disclosure can include repeating the steps of assigning each employee in the plurality of employees to one of the plurality of clusters and determining the benchmark for each cluster in the plurality of clusters at least monthly.

In some preferred embodiments of this disclosure the socio-economic information comprises information identifying, for each employee, a plurality of socio-economic factors selected from the group of socio-economic factors consisting of compensation, age, gender, marital status, tenure in current organization, residence location, and pay rate type. In some preferred embodiments of this disclosure the benchmark is selected from average contribution percentage to the retirement plan of the employees assigned to the cluster, average contribution percentage to the retirement plan of ten percent of the employees assigned to the cluster that have the highest contribution percentage to the retirement plan, or percentage of employees assigned to the cluster who are currently contributing to the retirement plan.

In some preferred embodiments of this disclosure identifying the selected cluster in the plurality of clusters for the selected employee comprises using selected socio-economic information for the selected employee and the machine learning model to identify the selected cluster. In some preferred embodiments of this disclosure displaying the benchmark for the selected cluster comprises displaying at the same time the benchmark for the selected cluster and a user interface for setting a contribution to the retirement plan by the selected employee.

The illustrative embodiments are intended to be compliant with regulations such as privacy laws. In particular, illustrative embodiments can include obtaining client consent on using their employee data and/or obtaining participant consent on using their data.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A, one of item B, and ten of item C; four of item B and seven of item C; or other suitable combinations.

As used herein, “a number of” when used with reference to items, means one or more items. For example, “a number of different types of networks” is one or more different types of networks.

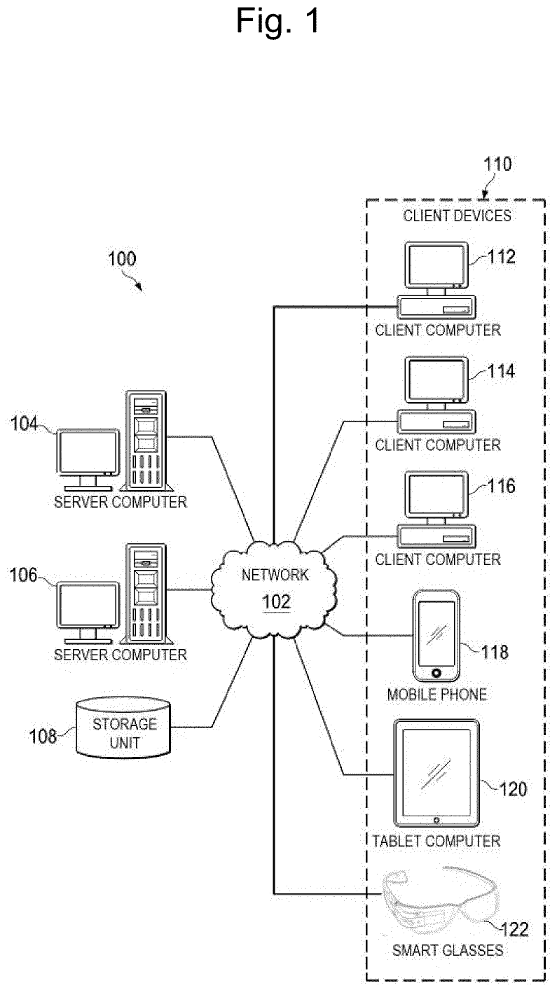

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. As depicted, client devices 110 include client computer 112, client computer 114, and client computer 116. Client devices 110 can be, for example, computers, workstations, or network computers. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

Network data processing system 100 may be the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

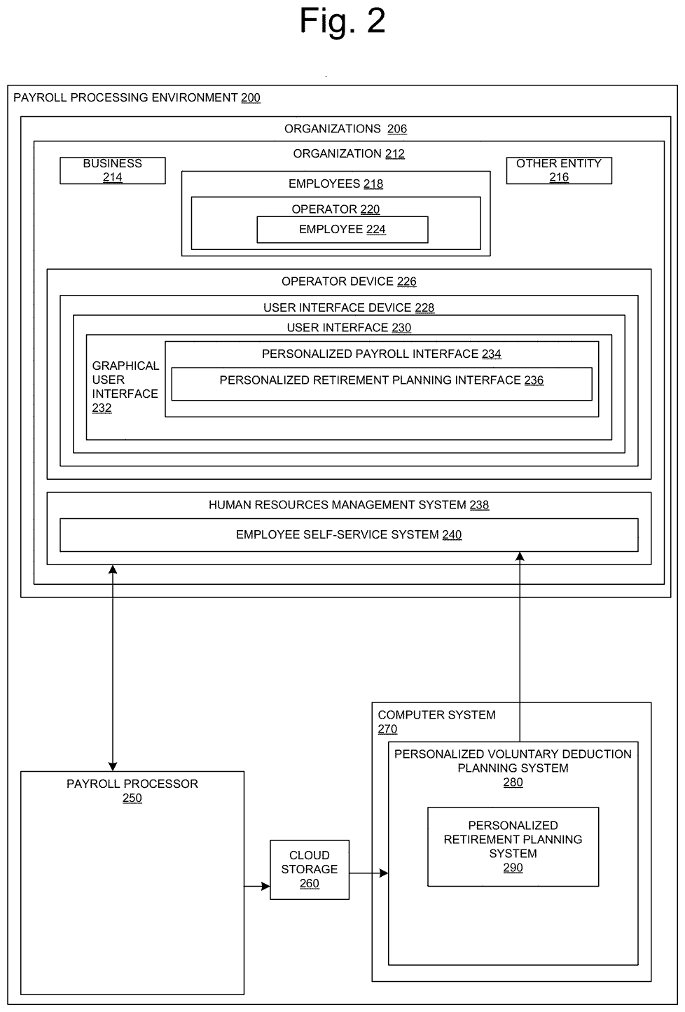

Turning to FIG. 2, an illustration of a block diagram of a payroll processing environment 200 is depicted in accordance with an illustrative embodiment. Payroll processing environment 200 may include any environment in which payroll processing may take place.

Payroll processing environment 200 includes organizations 206. Organizations 206 includes organization 212. Organization 212 includes business 214 and other entity 216. Organization 212 includes employees 218. Employees 218 includes operator 220. Operator 220 includes employee 224.

Organization 212 includes operator device 226. Operator device 226 includes user interface device 228. User interface device 228 includes user interface 230. User interface 230 includes graphical user interface 232. Graphical user interface 232 includes personalized payroll interface 234. Personalized payroll interface 234 includes personalized retirement planting interface 236.

Organization 212 includes human resources management system 238. Human resources management system 238 includes employee self-service system 240.

Human resources management system 238 is coupled to payroll processor 250. Payroll processor 250 is coupled to cloud storage 260.

Computer system 270 is coupled to employee self-service system 240. Computer system 270 includes personalized voluntary deduction planning system 280. Personalized voluntary deduction planning system is coupled to employee self-service system 240 personalized voluntary deduction planning system includes personalized retirement planning system 290. Personalized voluntary deduction planning system 280 is coupled to cloud storage 260.

The illustration of the different components in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

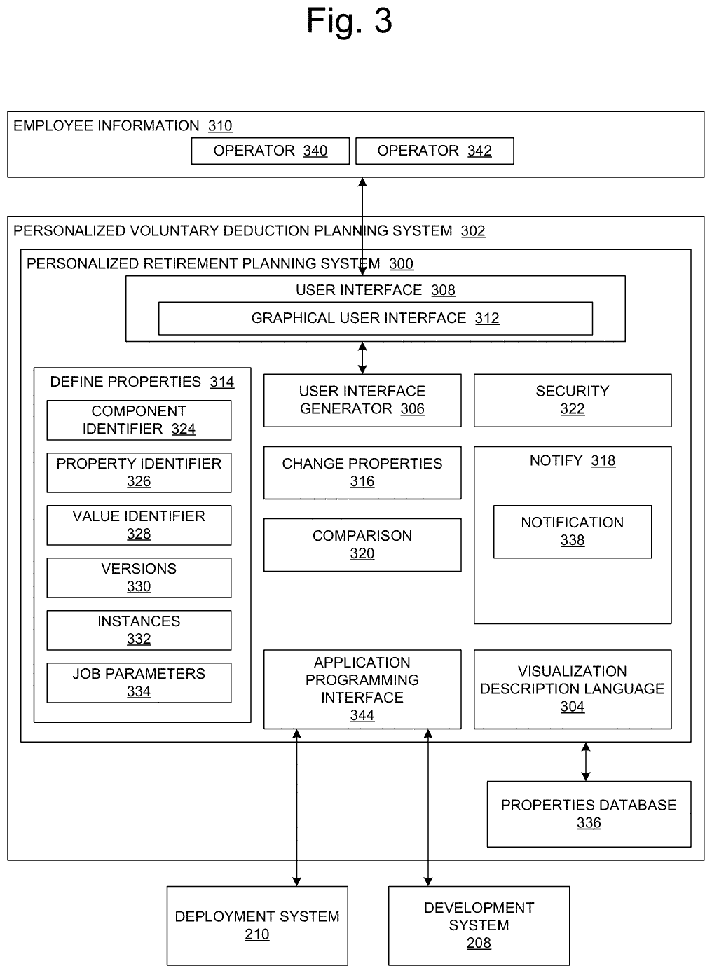

Turning to FIG. 3, an illustration of a block diagram of personalized retirement planning system 300 in context of a personalized voluntary deduction planning system 302 is depicted in accordance with an illustrative embodiment.

Employee information 310 is coupled to personalized voluntary deduction planning system 302. Employee information 310 includes operator 340 and operator 342. Operator 340 and operator 342 are participants.

Personalized retirement planning system 300 may be used, for example, by operator 340 or operator 342 to enroll or schedule contributions in payroll processing environment 200 in FIG. 2. Personalized voluntary deduction planning system 302 may be implemented in a computer system, such as network data processing system 100 in FIG. 1.

Personalized retirement planning system 300 includes user interface 308. User interface 308 includes graphical user interface 312. Operator 340 and operator 342 can interact with user interface 308 through personalized voluntary deduction planning system 302 and personalized retirement planning system 300. A user interface generator 306 is coupled to user interface 308.

Personalized retirement planning system 300 includes defined properties 314. Define properties 314 includes component identifier 324, property identifier 326, value identifier 328, versions 330, instances 332 and job parameters 334.

Personalized retirement planning system 300 includes change properties 316 and comparison 320. Personalized retirement planning system 300 also includes security 322 and notify 318. Notify 318 includes notification 338. Personalized retirement planning system 300 includes visualization description language 304. Personalized voluntary deduction planning system 302 includes properties database 336. Properties database 336 is coupled to personalized retirement planning system 300. Personalized retirement planning system 300 includes application programming interface 344. Application programming interface 344 is coupled to deployment system 210. Application programming interface 344 is also coupled to deployment system 208.

The illustration of the different components in FIG. 3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

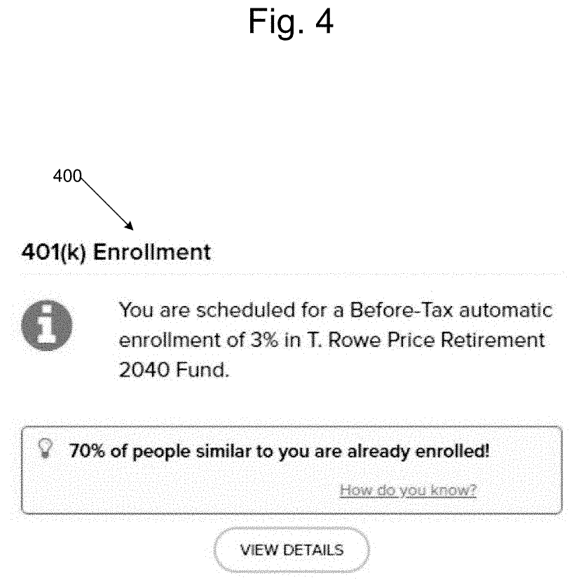

Turning to FIG. 4, an illustration of a user interface 400 is depicted in accordance with an illustrative embodiment. User interface 400 is an example of one implementation of user interface 308 in FIG. 3.

User interface 400 pertains to 401(k) enrollment. The user interface 400 includes the message that “you are scheduled for a before-tax automatic enrollment of 3% in T. Rowe Price retirement 2040 fund.” Of note, user interface 400 controls the display of the benchmark that “70% of people similar to you are already enrolled!” Additionally, the controlled display includes an option to drill for more information by “how do you know?”

User interface 400 may be implemented in any appropriate manner to perform the functions described herein. For example, without limitation, user interface 400 may be implemented as graphical user interface or voice interaction interface or may include the functionality of both graphical user interface and voice interaction interface. For graphical user interface, the participant interacts with user interface 400 via a display device and an input device, such as a mouse, track ball, a touch screen, or the like, for interaction with a displayed interface. For voice interaction interface, the participant interacts with user interface 400 via voice interaction using a speaker and microphone.

The illustration of the different components in FIG. 4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

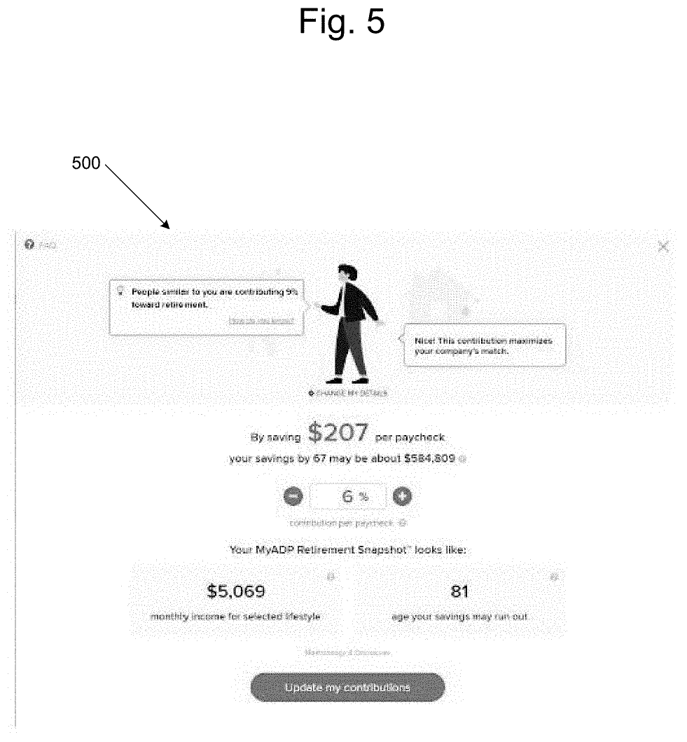

Turning to FIG. 5, an illustration of a user interface 500 is depicted in accordance with an illustrative embodiment. User interface 500 is an example of one implementation of user interface 308 in FIG. 3.

User interface 500 also pertains to 401(k) enrollment. The user interface 500 includes the message that “by saving $207 per paycheck your savings by 67 may be about $584,809.” Of note, user interface 500 controls the display of the benchmark that “people similar to you are contributing 9% toward retirement.” There is an associated message “nice! this contribution maximizes your company's match.” Additionally, the controlled display of the benchmark includes an option to drill for more information by “change my details.”

User interface 500 may be implemented in any appropriate manner to perform the functions described herein. For example, without limitation, user interface 500 may be implemented as graphical user interface or voice interaction interface or may include the functionality of both graphical user interface and voice interaction interface. For graphical user interface, the participant interacts with user interface 500 via a display device and an input device, such as a mouse, track ball, a touch screen, or the like, for interaction with a displayed interface. For voice interaction interface, the participant interacts with user interface 500 via voice interaction using a speaker and microphone.

The illustration of the different components in FIG. 5 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

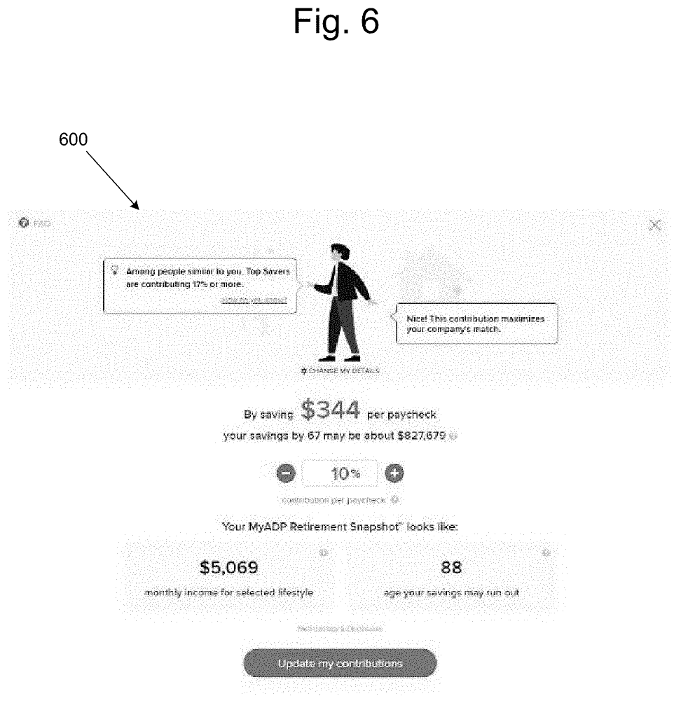

Turning to FIG. 6, an illustration of a user interface 600 is depicted in accordance with an illustrative embodiment. User interface 600 is an example of one implementation of user interface 308 in FIG. 3.

User interface 600 also pertains to 401(k) enrollment. The user interface 600 includes the message that “by saving $344 per paycheck your savings by 67 may be about $827,679.” Of note, user interface 600 controls the display of the benchmark that “among people similar to you top savers are contributing 17% or more.” There is an associated message “nice! this contribution maximizes your company's match.” Additionally, the controlled display of the benchmark includes an option to drill for more information by “change my details.”

User interface 600 may be implemented in any appropriate manner to perform the functions described herein. For example, without limitation, user interface 600 may be implemented as graphical user interface or voice interaction interface or may include the functionality of both graphical user interface and voice interaction interface. For graphical user interface, the participant interacts with user interface 600 via a display device and an input device, such as a mouse, track ball, a touch screen, or the like, for interaction with a displayed interface. For voice interaction interface, the participant interacts with user interface 600 via voice interaction using a speaker and microphone.

The illustration of the different components in FIG. 6 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

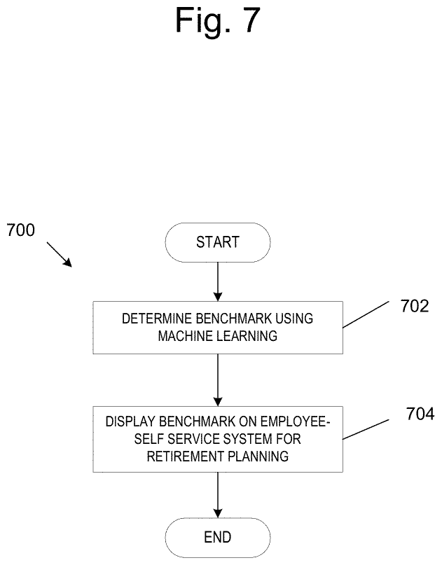

Turning to FIG. 7, an illustration of a flowchart of detail from a process for setting an employee contribution to a retirement plan is depicted in accordance with an illustrative embodiment. Process 700 may be implemented, for example, via personalized retirement planning system 300 of FIG. 3 and personalized retirement planning system of FIG. 2.

Process 700 may begin with receiving a request from a participant to control display of a benchmark. Information may be needed from the participant to perform the requested display. Operation 702 determines a benchmark using machine learning. Operation 702 is performed before operation 704.

Operation 704 displays the benchmark on the employee self-service system for retirement planning. In response to controlling display of the benchmark on the employee self-service system for retirement planning (operation 704), process 700 terminates thereafter.

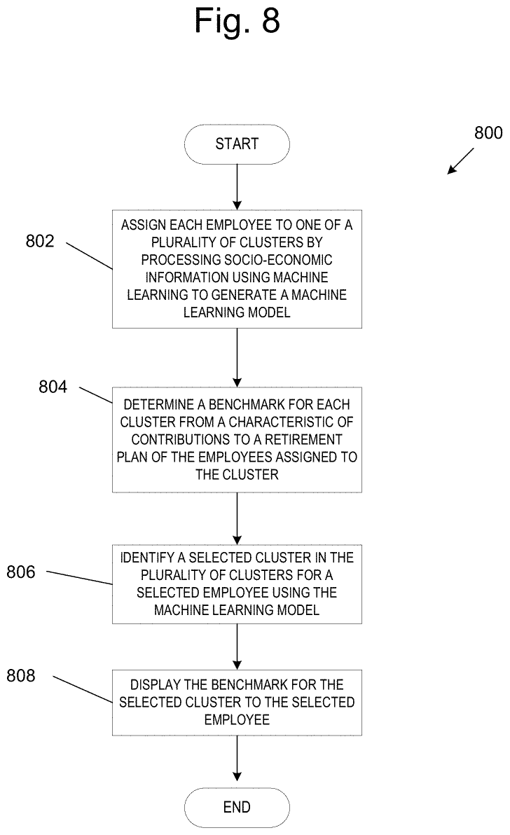

Turning to FIG. 8, an illustration of a flowchart of detail from a process for setting an employee contribution to a retirement plan is depicted in accordance with an illustrative embodiment. Process 800 may be implemented, for example, via personalized retirement planning system 300 of FIG. 3 and personalized retirement planning system of FIG. 2.

Process 800 may begin with receiving a request from a participant to control display of a benchmark. Information may be needed from the participant to perform the requested display. Operation 802 assigns each employee to one of a plurality of clusters by processing socio-economic information using machine learning to generate a machine learning model. Operation 804 determines a benchmark for each cluster from a characteristic of contributions to a retirement plan of the employees assigned to the cluster. Operation 806 identifies a selected cluster in the plurality of clusters for a selected employee using the machine learning model. Operations 802, 804, and 806 may be performed in any order.

Operation 808 displays the benchmark for the selected cluster to the selected employee. In response to controlling display of the benchmark on the employee self-service system for retirement planning (operation 808), process 800 terminates thereafter.

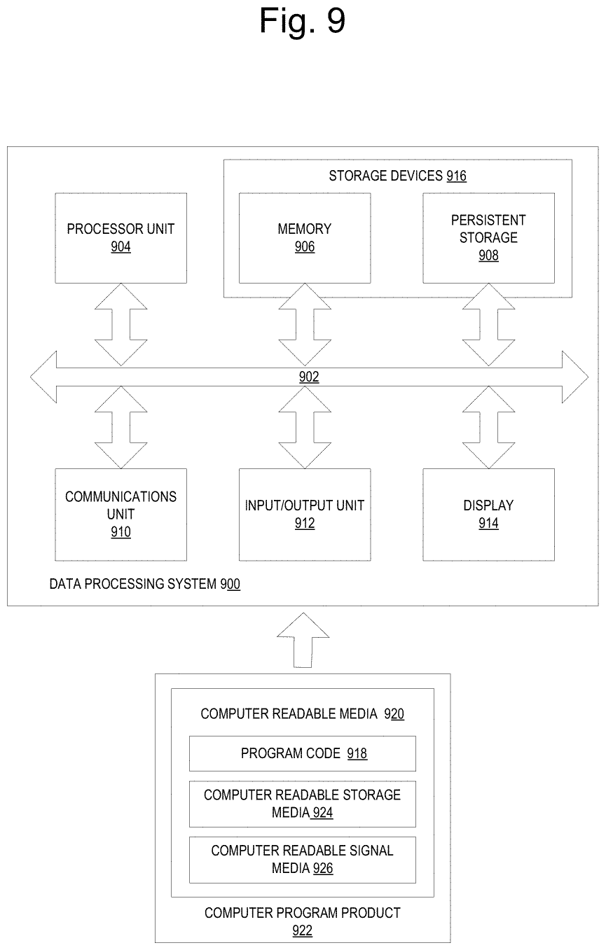

Turning now to FIG. 9, an illustration of a block diagram of a data processing system is depicted in accordance with an illustrative embodiment. Data processing system 900 may be used to implement one or more of server computer 104 in FIG. 1, server computer 106 in FIG. 1, and client devices 110 in FIG. 1. In this illustrative example, data processing system 900 includes communications framework 902, which provides communications between processor unit 904, memory 906, persistent storage 908, communications unit 910, input/output unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (GPUs).

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer-usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918. Alternatively, program code 918 may be transferred to data processing system 900 using computer-readable signal media 926.

Computer-readable signal media 926 may be, for example, a propagated data signal containing program code 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

Further, as used herein, “computer-readable media” can be singular or plural. For example, program code 918 can be located in computer-readable media 920 in the form of a single storage device or system. In another example, program code 918 can be located in computer-readable media 920 that is distributed in multiple data processing systems. In other words, some instructions in program code 918 can be located in one data processing system while other instructions in program code 918 can be located in another data processing system. For example, a portion of program code 918 can be located in computer-readable media 920 in a server computer while another portion of program code 918 can be located in computer-readable media 920 located in a set of client computers.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of setting an employee contribution to a retirement plan, comprising:
assigning, by a personalized voluntary deduction planning system, each employee in a plurality of employees to one of a plurality of clusters by processing socio-economic information for the plurality of employees using machine learning to generate a machine learning model;
determining, by the personalized voluntary deduction planning system, a benchmark for each cluster in the plurality of clusters from a characteristic of contributions to a retirement plan of the employees assigned to the cluster;
identifying, by the personalized voluntary deduction planning system, a selected cluster in the plurality of clusters for a selected employee using the machine learning model; and
controlling displaying, by a graphical user interface, the benchmark for the selected cluster to the selected employee.

2. The method of claim 1 further comprising reading the socio-economic information from payroll information for the plurality of employees.

3. The method of claim 1, wherein the socio-economic information comprises information identifying, for each employee, a plurality of socio-economic factors selected from the group of socio-economic factors consisting of compensation, age, gender, marital status, tenure in current organization, residence location, and pay rate type.

4. The method of claim 1, wherein the benchmark is selected from average contribution percentage to the retirement plan of the employees assigned to the cluster, average contribution percentage to the retirement plan of ten percent of the employees assigned to the cluster that have the highest contribution percentage to the retirement plan, or percentage of employees assigned to the cluster who are currently contributing to the retirement plan.

5. The method of claim 1, wherein identifying the selected cluster in the plurality of clusters for the selected employee comprises using selected socio-economic information for the selected employee and the machine learning model to identify the selected cluster.

6. The method of claim 1, wherein displaying the benchmark for the selected cluster comprises displaying at the same time the benchmark for the selected cluster and a user interface for setting a contribution to the retirement plan by the selected employee.

7. The method of claim 1 further comprising repeating the steps of assigning each employee in the plurality of employees to one of the plurality of clusters and determining the benchmark for each cluster in the plurality of clusters at least monthly.

8. An apparatus for setting an employee contribution to a retirement plan, comprising:
a human resources management system comprising an employee self-service system;
a personalized voluntary deduction planning system coupled to the human resources management system, the personalized voluntary deduction planning system comprising a personalized retirement planning system, the personalized voluntary deduction planning system configured to
assign each employee in a plurality of employees to one of a plurality of clusters by processing socio-economic information for the plurality of employees using machine learning to generate a machine learning model;
determine a benchmark for each cluster in the plurality of clusters from a characteristic of contributions to a retirement plan of the employees assigned to the cluster; and
identify a selected cluster in the plurality of clusters for a selected employee using the machine learning model; and
a graphical user interface coupled to the human resources management system, the graphical user interface comprising a personalized payroll interface comprising a personalized retirement planning interface, the graphical user interface is configured to control display of the benchmark for the selected cluster to the selected employee.

9. The apparatus of claim 8, wherein the personalized voluntary deduction planning system is configured to read the socio-economic information from payroll information for the plurality of employees.

10. The apparatus of claim 8, wherein the socio-economic information comprises information identifying, for each employee, a plurality of socio-economic factors selected from the group of socio-economic factors consisting of compensation, age, gender, marital status, tenure in current organization, residence location, and pay rate type.

11. The apparatus of claim 8, wherein the benchmark is selected from average contribution percentage to the retirement plan of the employees assigned to the cluster, average contribution percentage to the retirement plan of ten percent of the employees assigned to the cluster that have the highest contribution percentage to the retirement plan, or percentage of employees assigned to the cluster who are currently contributing to the retirement plan.

12. The apparatus of claim 8, wherein identify the selected cluster in the plurality of clusters for the selected employee comprises using selected socio-economic information for the selected employee and the machine learning model to identify the selected cluster.

13. The apparatus of claim 8, wherein display the benchmark for the selected cluster comprises display at the same time the benchmark for the selected cluster and a user interface for setting a contribution to the retirement plan by the selected employee.

14. The apparatus of claim 8, wherein the personalized voluntary deduction planning system is configured to repeat the steps of assigning each employee in the plurality of employees to one of the plurality of clusters and determining the benchmark for each cluster in the plurality of clusters at least monthly.

15. A computer program product for setting an employee contribution to a retirement plan, the computer program product comprising a computer readable storage medium having program instructions embodied therewith, the program instructions executable by a device to cause the device to:
assign, by a personalized voluntary deduction planning system, each employee in a plurality of employees to one of a plurality of clusters by processing socio-economic information for the plurality of employees using machine learning to generate a machine learning model;
determine, by the personalized voluntary deduction planning system, a benchmark for each cluster in the plurality of clusters from a characteristic of contributions to a retirement plan of the employees assigned to the cluster;
identify, by the personalized voluntary deduction planning system, a selected cluster in the plurality of clusters for a selected employee using the machine learning model; and
control display, by a graphical user interface, the benchmark for the selected cluster to the selected employee.

16. The computer program product of claim 15, wherein the program instructions cause the device to read the socio-economic information from payroll information for the plurality of employees.

17. The computer program product of claim 15, wherein the socio-economic information comprises information identifying, for each employee, a plurality of socio-economic factors selected from the group of socio-economic factors consisting of compensation, age, gender, marital status, tenure in current organization, residence location, and pay rate type.

18. The computer program product of claim 15, wherein the benchmark is selected from average contribution percentage to the retirement plan of the employees assigned to the cluster, average contribution percentage to the retirement plan of ten percent of the employees assigned to the cluster that have the highest contribution percentage to the retirement plan, or percentage of employees assigned to the cluster who are currently contributing to the retirement plan.

19. The computer program product of claim 15, wherein identifying the selected cluster in the plurality of clusters for the selected employee comprises using selected socio-economic information for the selected employee and the machine learning model to identify the selected cluster.

20. The computer program product of claim 15, wherein displaying the benchmark for the selected cluster comprises displaying at the same time the benchmark for the selected cluster and a user interface for setting a contribution to the retirement plan by the selected employee.

21. The computer program product of claim 15, wherein the program instructions cause the device to repeat the steps of assigning each employee in the plurality of employees to one of the plurality of clusters and determining the benchmark for each cluster in the plurality of clusters at least monthly.
